(19) United States
(12) Patent Application Publication
(10) Pub. No.: US 2025/0172397 A1
(43) Pub. Date: May 29, 2025

(54) POSITION ACQUIRING DEVICE AND RECORDING MEDIUM IN WHICH POSITION ACQUIRING PROGRAM IS RECORDED

(71) Applicant: SEIKO EPSON CORPORATION, Tokyo (JP)

(72) Inventor: Koichiro YANO, MATSUMOTO-SHI (JP)

(73) Assignee: SEIKO EPSON CORPORATION, Tokyo (JP)

(21) Appl. No.: 18/959,546

(22) Filed: Nov. 25, 2024

(30) Foreign Application Priority Data
Nov. 27, 2023 (JP) 2023-199658

(51) Int. Cl. G01C 21/18; G01C 21/16

(52) U.S. Cl. CPC G01C 21/18; G01C 21/183

(57) ABSTRACT

A position acquiring device attached to a pallet to be transported and configured to acquire position information indicating a position of the pallet from a GNSS system includes: a movement determining unit configured to determine a movement state of the pallet; a reception-state determining unit configured to determine a reception state of a position signal from the GNSS system; and an acquiring unit configured to acquire the position information in accordance with a result of determination by the movement determining unit and a result of determination by the reception-state determining unit.

The present application is based on, and claims priority from JP Application Serial Number 2023-199658, filed Nov. 27, 2023, the disclosure of which is hereby incorporated by reference herein in its entirety.

### BACKGROUND

### 1. Technical Field

The present disclosure relates to a position acquiring device and a recording medium in which a position acquiring program is recorded.

### 2. Related Art

JP-A-2018-47932 describes a position-information acquiring terminal attached to a pallet and including an acceleration sensor. When the acceleration sensor detects acceleration equal to or more than a predetermined threshold value, the position-information acquiring terminal acquires position information.

In the technique described in JP-A-2018-47932, the position determination is performed when movement of the pallet is detected, regardless of environment where the position-information acquiring terminal is disposed. Thus, the position determining process is performed, for example, even when a position signal from satellites cannot be appropriately received. This leads to a possibility of uselessly consuming the electrical power.

### SUMMARY

One aspect of the present disclosure provides a position acquiring device attached to a target object to be transported and configured to acquire position information indicating a position of the target object from a GNSS system, the position acquiring device including a movement determining unit configured to determine a movement state of the target object, a reception-state determining unit configured to determine a reception state of a position signal from the GNSS system, and an acquiring unit configured to acquire the position information in accordance with a result of determination by the movement determining unit and the reception-state determining unit.

Another one aspect of the present disclosure provides a recording medium, of a position acquiring device, in which a position acquiring program is recorded, the position acquiring device including a processor, the position acquiring device being attached to a target object to be transported, the position acquiring device being configured to acquire position information indicating a position of the target object from a GNSS system, the program causing the processor to function as: a movement determining unit configured to determine a movement state of the target object, a reception-state determining unit configured to determine a reception state of a position signal from the GNSS system, and an acquiring unit configured to acquire the position information in accordance with a result of determination by the movement determining unit and a result of determination by the reception-state determining unit.

### BRIEF DESCRIPTION OF THE DRAWINGS

FIG. 1 is a diagram illustrating one example of the configuration of a position acquiring device according to the present embodiment.

FIG. 2 is a diagram illustrating one example of the layout of the position acquiring device in a pallet.

FIG. 3 is a diagram illustrating one example of output from a gyro sensor.

FIG. 4 is a diagram illustrating another example of output from the gyro sensor.

FIG. 5 is a flowchart showing one example of a process of a control unit.

FIG. 6 is a flowchart showing one example of a process of the control unit.

### DESCRIPTION OF EMBODIMENTS

Below, the present embodiment will be described with reference to the drawings.

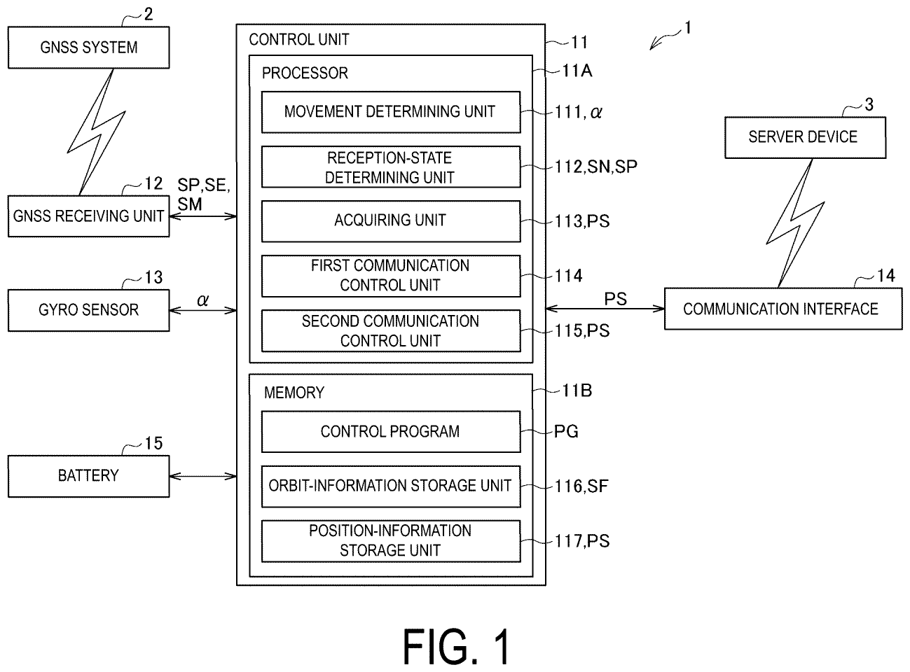

FIG. 1 is a diagram illustrating one example of the configuration of a position acquiring device 1 according to the present embodiment. The position acquiring device 1 includes a control unit 11, a GNSS receiving unit 12, a gyro sensor 13, a communication interface 14, and a battery 15.

The control unit 11 controls each component in the position acquiring device 1. The battery 15 supplies electrical power to each component of the position acquiring device 1 in accordance with an instruction of the control unit 11.

The GNSS receiving unit 12 receives a GNSS signal from a global navigation satellite system (GNSS) system 2 in accordance with an instruction of the control unit 11. The GNSS receiving unit 12 includes an antenna. The GNSS receiving unit 12 outputs, to the control unit 11, the GNSS signal received from the GNSS system 2.

The GNSS signal includes a position signal SP, an orbit signal SE, and a number signal SM. The position signal SP corresponds to position information PS indicating the position of the GNSS receiving unit 12. The orbit signal SE indicates orbit information SF concerning a satellite. The number signal SM indicates the number SN of satellites used in calculating the position information PS.

In addition, the GNSS receiving unit 12 turns on and off in accordance with an instruction of the control unit 11.

The GNSS receiving unit 12 includes an integrated circuit (IC), for example.

The gyro sensor 13 detects an angular velocity α of the position acquiring device 1.

The position acquiring device 1 is disposed at a pallet 4.

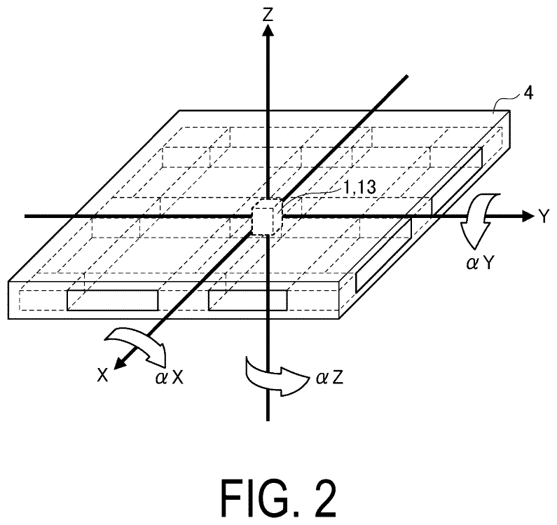

The pallet 4 and the angular velocity α will be further described with reference to FIG. 2.

The communication interface 14 includes a conductive connector and an interface circuit, and is coupled to the control unit 11. The communication interface 14 is an interface used to communicate with the server device 3. The communication interface 14 is an interface used to communicate with the server device 3 in accordance with a Wi-Fi (registered trademark) standard, for example.

The server device 3 receives the position information PS concerning the pallet 4 from the position acquiring device 1. In addition, the server device 3 tracks the position of the pallet 4 on the basis of the received position information PS. The server device 3 is coupled to a smartphone (not illustrated) so as to be able to communicate with each other, and transmits the position of the pallet 4 to the smartphone.

The control unit 11 includes a processor 11A and a memory 11B.

The memory 11B is a storage device that holds a program to be implemented by the processor 11A or data in a non-volatile manner. The memory 11B is comprised of a magnetic storage device, a semiconductor storage element such as a flash read-only memory (ROM), or other types of non-volatile storage device. In addition, the memory 11B may include a random access memory (RAM) that constitutes a work area of the processor 11A. The memory 11B holds data to be processed by the control unit 11, a control program PG to be executed by the processor 11A, and the like.

The processor 11A may be configured by a single processor, or it may be possible to employ a configuration in which a plurality of processors function as the processor 11A. The processor 11A executes the control program PG to control each component of the position acquiring device 1.

The control program PG corresponds to one example of a “position acquiring program”.

The memory 11B corresponds to one example of a “recording medium”.

The processor 11A may be configured as a system on chip (SoC) integrated with a portion of or all of the memory 11B, or with other circuits. In addition, the processor 11A may be configured by combining a central processing unit (CPU) that executes a program and a digital signal processor (DSP) that performs a predetermined computation process together. It may be possible to employ a configuration in which all of the functions of the processor 11A are implemented in hardware, or all of the functions of the processor 11A may be configured using a programmable device.

Below, description will be made of a case where the processor 11A executes the control program PG to control each component of the position acquiring device 1.

Next, the pallet 4 and the angular velocity α will be described with reference to FIG. 2. FIG. 2 is a diagram illustrating one example of the layout of the position acquiring device 1 at the pallet 4. The pallet 4 is made, for example, of wood or plastic or the like.

As illustrated in FIG. 2, the position acquiring device 1 is disposed at the substantial center in the X-axis direction and the Y-axis direction of the pallet 4. The present embodiment describes a case in which the upper surface of and the lower surface of the pallet 4 are disposed so as to be parallel to the horizontal direction.

The X-axis, the Y-axis, and the Z-axis are perpendicular to each other. The X-axis and the Y-axis are parallel to the horizontal direction. The Z-axis is parallel to the vertical direction. The X-axis is parallel to the front-rear direction of the pallet 4. The Y-axis is parallel to the left-right direction of the pallet 4. The positive direction of the X-axis indicates the forward direction of the pallet 4. The positive direction of the Y-axis indicates the rightward direction of the pallet 4. The positive direction of the Z-axis indicates the upward direction of the pallet 4.

The pallet 4 corresponds to one example of a target object to be transported.

Cargo is loaded on the upper surface of the pallet 4. The pallet 4 is transported by a first transport device TE1 and a second transport device TE2. The first transport device TE1 includes a fork lift FL. The second transport device TE2 is a transport device differing from the first transport device TE1, and includes a truck TR.

The first transport device TE1 is configured such that the GNSS receiving unit 12 is able to receive a GNSS signal having an appropriate intensity from the GNSS system 2 when the pallet 4 is transported by the first transport device TE1.

The second transport device TE2 is configured such that the GNSS receiving unit 12 is not able to receive a GNSS signal having an appropriate intensity from the GNSS system 2 when the pallet 4 is transported by the second transport device TE2.

The present embodiment describes a case where the first transport device TE1 is the fork lift FL, and the second transport device TE2 is the truck TR.

The pallet 4 loaded on the truck TR is brought by the fork lift FL into a warehouse, for example. In addition, the fork lift FL brings out the pallet 4 placed in the warehouse, and load it on the truck TR. In this manner, the fork lift FL moves outdoors or around the entrance area of the warehouse. This enables the position acquiring device 1 at the pallet 4 transported by the fork lift FL to receive the GNSS signal having an appropriate intensity from the GNSS system 2.

The truck TR transports a plurality of pallets 4, for example, from the point of departure to the warehouse, or from the warehouse to another warehouse, or from the warehouse to the transport destination. The truck TR includes a metal cargo storage disposed at the loading space, and the plurality of pallets 4 are loaded in the cargo storage. Thus, the position acquiring device 1 at the pallet 4 transported by the truck TR is not able to receive the GNSS signal having an appropriate intensity from the GNSS system 2.

The fork lift FL corresponds to one example of a “first transport device”.

The truck TR corresponds to one example of a “second transport device”.

Note that, when the pallet 4 is transported by the fork lift FL, the forward direction of the pallet 4 matches the forward direction of the fork lift FL, the rightward direction of the pallet 4 matches the rightward direction of the fork lift FL, and the upward direction of the pallet 4 matches the upward direction of the fork lift FL.

In addition, when the pallet 4 is transported by the truck TR, the forward direction of the pallet 4 matches the forward direction of the truck TR, the rightward direction of the pallet 4 matches the rightward direction of the truck TR, and the upward direction of the pallet 4 matches the upward direction of the truck TR.

The angular velocity α is comprised of an X-axis angular velocity αX, a Y-axis angular velocity αY, and a Z-axis angular velocity αZ. The angular velocity α indicates a rotational angle per unit time.

The gyro sensor 13 of the position acquiring device 1 detects the X-axis angular velocity αX, the Y-axis angular velocity αY, and the Z-axis angular velocity αZ as the angular velocity α. In addition, the gyro sensor 13 outputs, to the control unit 11, the detected X-axis angular velocity αX, the Y-axis angular velocity αY, and the Z-axis angular velocity αZ.

The X-axis angular velocity αX indicates the clockwise angular velocity α with respect to the positive direction of the X-axis. For example, when the angle of the pallet 4 in the left-right direction changes, the X-axis angular velocity αX is generated.

The Y-axis angular velocity αY indicates the clockwise angular velocity α with respect to the positive direction of the Y-axis. For example, when the angle of the pallet 4 in the front-rear direction changes, the Y-axis angular velocity αY is generated.

The Z-axis angular velocity αZ indicates the clockwise angular velocity α with respect to the positive direction of the Z-axis. For example, when the pallet 4 rotates with the Z-axis being the center, the Z-axis angular velocity αZ is generated.

Next, returning to FIG. 1, description will be made of a functional configuration of the control unit 11 with reference to FIG. 1. The control unit 11 includes a movement determining unit 111, a reception-state determining unit 112, an acquiring unit 113, a first communication control unit 114, a second communication control unit 115, an orbit-information storage unit 116, and a position-information storage unit 117.

Specifically, the processor 11A executes the control program PG to function as the movement determining unit 111, the reception-state determining unit 112, the acquiring unit 113, the first communication control unit 114, and the second communication control unit 115. In addition, the processor 11A executes the control program PG to cause the memory 11B to function as the orbit-information storage unit 116 and the position-information storage unit 117.

The orbit-information storage unit 116 holds the orbit information SF concerning a satellite. The orbit information SF corresponds to the orbit signal SE. The orbit signal SE is included in the GNSS signal that the GNSS receiving unit 12 receives from the GNSS system 2. The orbit information SF corresponds to so-called ephemeris.

The orbit information SF corresponds to the orbit signal SE acquired by the acquiring unit 113 from the GNSS receiving unit 12. In addition, the acquiring unit 113 stores the orbit information SF in the orbit-information storage unit 116. In addition, the orbit information SF held in the orbit-information storage unit 116 is updated by the acquiring unit 113.

The orbit-information storage unit 116 corresponds to one example of a “storage unit”.

The position-information storage unit 117 holds the position information PS indicating the position of the GNSS receiving unit 12. The position information PS corresponds to the position signal SP acquired by the acquiring unit 113 from the GNSS receiving unit 12. In addition, the position information PS is stored by the acquiring unit 113 in the position-information storage unit 117.

The movement determining unit 111 determines a movement state of the pallet 4. The movement determining unit 111 determines the movement state of the pallet 4 on the basis of output from the gyro sensor 13, for example. In addition, the movement determining unit 111 determines whether the pallet 4 is moved by the fork lift FL or is moved by the truck TR, on the basis of output from the gyro sensor 13.

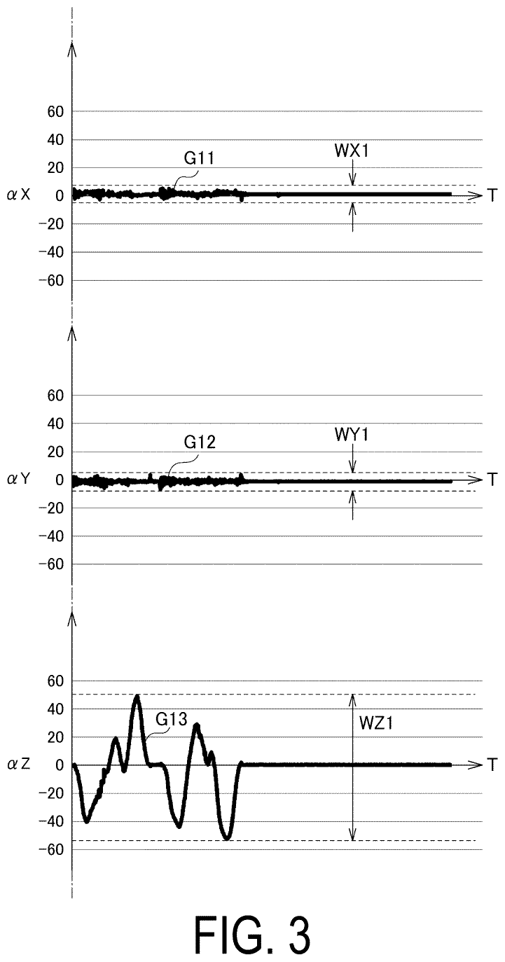

The process of the movement determining unit 111 will be further described with reference to FIG. 3 to FIG. 5.

The reception-state determining unit 112 determines a reception state of a signal from the GNSS system 2. The reception-state determining unit 112 determines the reception state of a signal from the GNSS system 2 on the basis of whether or not the orbit information SF concerning a satellite is held in the orbit-information storage unit 116, for example.

In addition, the reception-state determining unit 112 determines that the reception state of the position signal SP is not favorable when the number SN of satellites used in calculating the position information PS is equal to or less than 3, for example.

The reception-state determining unit 112 performs the following process when the number SN of satellites used in calculating the position information PS is equal to or more than 4, for example.

That is, for example, when the orbit information SF is held in the orbit-information storage unit 116, the reception-state determining unit 112 determines that the reception state of the position signal SP is favorable in a case where a signal-to-noise ratio of the position signal SP is equal to or more than a first threshold value TH1. The first threshold value TH1 is “10”, for example.

The “orbit information SF is held in the orbit-information storage unit 116” means that, for all satellites used in calculating the position information PS, the orbit information SF concerning each of the satellites is held in the orbit-information storage unit 116.

Furthermore, for example, when the orbit information SF is not held in the orbit-information storage unit 116, the reception-state determining unit 112 determines that the reception state of the position signal SP is favorable in a case where a signal-to-noise ratio of the position signal SP is equal to or more than a second threshold value TH2. The second threshold value TH2 is larger than the first threshold value TH1. The second threshold value TH2 is “30”, for example.

The “orbit information SF is not held in the orbit-information storage unit 116” means that, for a plurality of satellites used in calculating the position information PS, the orbit information SF concerning at least one satellite of the plurality of satellites is not held in the orbit-information storage unit 116.

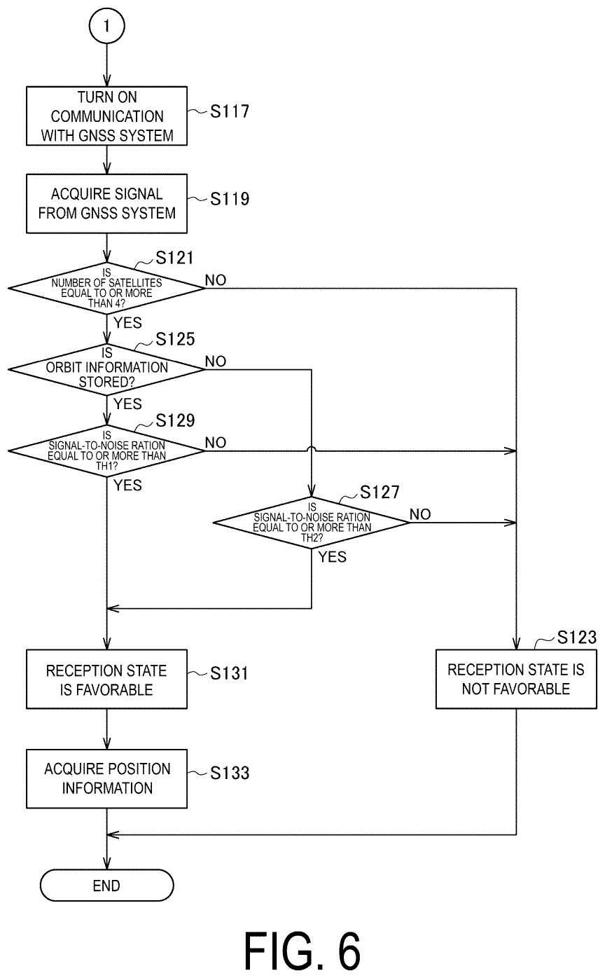

The process of the reception-state determining unit 112 will be further described with reference to FIG. 6.

The acquiring unit 113 acquire the position information PS in accordance with a result of determination by the movement determining unit 111 and a result of determination by the reception-state determining unit 112. The position information PS corresponds to the position signal SP. The position signal SP is included in the GNSS signal that the GNSS receiving unit 12 receives from the GNSS system 2. That is, for example, when the GNSS receiving unit 12 receives the GNSS signal from the GNSS system 2, the acquiring unit 113 acquires the position information PS on the basis of the position signal SP included in the GNSS signal.

The acquiring unit 113 acquires the position information PS when the movement determining unit 111 determines that the pallet 4 is moved by the fork lift FL and the reception-state determining unit 112 determines that the reception state of the position signal SP is favorable, for example.

When acquiring the position information PS, the acquiring unit 113 causes the acquired position information PS to be stored in the position-information storage unit 117.

In addition, for example, when the GNSS receiving unit 12 receives the GNSS signal from the GNSS system 2, the acquiring unit 113 acquires the orbit information SF on the basis of the orbit signal SE included in the GNSS signal.

When acquiring the orbit information SF, the acquiring unit 113 causes the acquired orbit information SF to be stored in the orbit-information storage unit 116.

Furthermore, when a predetermined period of time elapses from when the orbit information SF is acquired, the acquiring unit 113 updates the orbit information SF stored in the orbit-information storage unit 116. The predetermined period of time is, for example, four hours.

In other words, when a predetermined period of time elapses from when the acquiring unit 113 acquires the orbit information SF, the acquiring unit 113 causes the GNSS receiving unit 12 to receive the GNSS signal from the GNSS system 2, and acquires the orbit information SF on the basis of the orbit signal SE included in the GNSS signal. In addition, the acquiring unit 113 updates the orbit information SF stored in the orbit-information storage unit 116, with the acquired orbit information SF.

Note that, in a case where the GNSS receiving unit 12 is not able to receive the GNSS signal from the GNSS system 2 when a predetermined period of time elapses from when the orbit information SF is acquired, the acquiring unit 113 deletes the orbit information SF stored in the orbit-information storage unit 116.

The first communication control unit 114 controls communication of the GNSS receiving unit 12 with the GNSS system 2.

For example, when the movement determining unit 111 determines that the pallet 4 is moved by the fork lift FL, the first communication control unit 114 turns on the power supply of the GNSS receiving unit 12. In other words, when the movement determining unit 111 determines that the pallet 4 is moved by the fork lift FL, communication between the GNSS receiving unit 12 and the GNSS system 2 is established.

For example, when the movement determining unit 111 determines that the pallet 4 is moved by the truck TR, the first communication control unit 114 turns off the power supply of the GNSS receiving unit 12. In addition, when the movement determining unit 111 determines that the pallet 4 is not moved, the first communication control unit 114 turns off the power supply of the GNSS receiving unit 12.

The second communication control unit 115 transmits the position information PS through the communication interface 14 to the server device 3, for example.

Note that the second communication control unit 115 transmits the position information PS to the server device 3 every time the acquiring unit 113 acquires the position information PS, for example. In this case, when the acquiring unit 113 acquires the position information PS, the second communication control unit 115 turns on the power supply of the communication interface 14. In other words, when the acquiring unit 113 acquires the position information PS, communication between the communication interface 14 and the server device 3 is established.

Furthermore, the second communication control unit 115 may transmit the position information PS to the server device 3 every time a predetermined period of time elapses, for example. The predetermined period of time is, for example, 10 minutes.

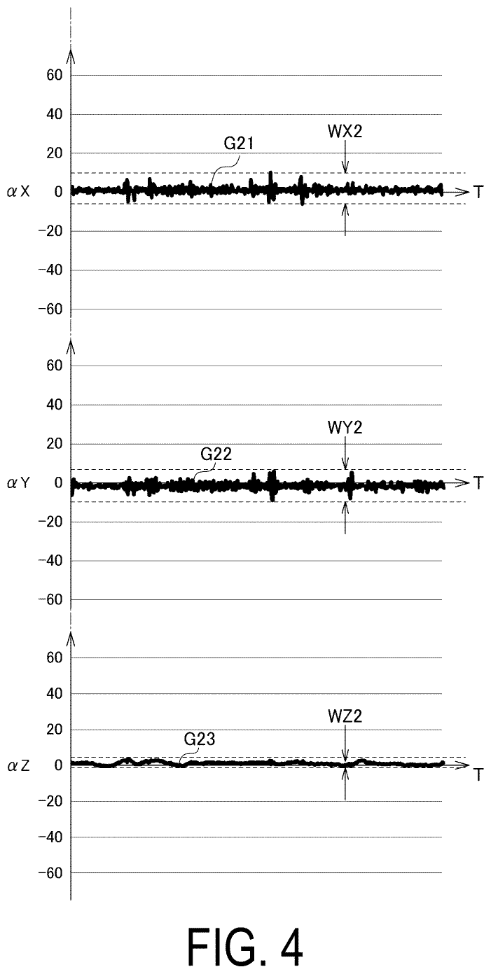

Next, the process of the movement determining unit 111 will be described with reference to FIGS. 3 and 4. FIG. 3 is a diagram illustrating one example of output from the gyro sensor 13 when the pallet 4 is transported by the fork lift FL. FIG. 4 is a diagram illustrating one example of output from the gyro sensor 13 when the pallet 4 is transported by the truck TR.

In each of the three graphs shown in FIG. 3, the horizontal axis indicates time T. In the graph shown in the upper section of FIG. 3, the vertical axis indicates the X-axis angular velocity αX. In the graph shown in the middle section of FIG. 3, the vertical axis indicates the Y-axis angular velocity αY. In the graph shown in the lower section of FIG. 3, the vertical axis indicates the Z-axis angular velocity αZ. The units of the X-axis angular velocity αX, the Y-axis angular velocity αY, and the Z-axis angular velocity αZ are deg/sec.

The graph G11 shown in the upper section of FIG. 3 shows a change in the X-axis angular velocity αX. The graph G12 shown in the middle section of FIG. 3 shows a change in the Y-axis angular velocity αY. The graph G13 shown in the lower section of FIG. 3 shows a change in the Z-axis angular velocity αZ.

The X-axis amplitude WX1 indicates the amplitude of the X-axis angular velocity αX in the graph G11. The Y-axis amplitude WY1 indicates the amplitude of the Y-axis angular velocity αY in the graph G12. The Z-axis amplitude WZ1 indicates the amplitude of the Z-axis angular velocity αZ in the graph G13.

As illustrated in FIG. 3, the Z-axis amplitude WZ1 is larger than the X-axis amplitude WX1 and the Y-axis amplitude WY1, and satisfies the Equation (1), the Equation (2), and the Equation (3) described below, for example.

$$WZ 1 \geq THA \qquad ( 1 )$$

$$WZ 1 / WX 1 \geq THB \qquad ( 2 )$$

$$WZ 1 / WY 1 \geq THB \qquad ( 3 )$$

Note that the amplitude threshold value THA is, for example, 50 deg/sec. In addition, the amplitude-ratio threshold value THB is, for example, 5.

When the X-axis amplitude WX1, the Y-axis amplitude WY1, and the Z-axis amplitude WZ1 satisfy the Equation (1), the Equation (2), and the Equation (3), the movement determining unit 111 determines that the pallet 4 is transported by the fork lift FL.

Description below will be made of the reason that the Z-axis amplitude WZ1 is larger than the X-axis amplitude WX1 and the Y-axis amplitude WY1 when the pallet 4 is transported by the fork lift FL.

The X-axis amplitude WX1 and the Y-axis amplitude WY1 correspond to an angle at which the pallet 4 is tilted with respect to the horizontal surface. There is a case where a plurality of cargoes (for example, cardboard boxes) are stacked at the pallet 4. Thus, when the pallet 4 is transported by the fork lift FL, a travel path of the fork lift FL is formed substantially horizontally such that the angle at which the pallet 4 is tilted with respect to the horizontal surface is equal to or less than a predetermined value. That is, the X-axis angular velocity αX and the Y-axis angular velocity αY are limited within a predetermined range.

In addition, when the fork lift FL changes traveling directions, the angle of rotation with the Z-axis being the center largely changes. This leads to generation of a relatively large Z-axis angular velocity αZ as compared with the X-axis angular velocity αX and the Y-axis angular velocity αY.

Thus, as illustrated in FIG. 3, the Z-axis amplitude WZ1 has a relatively large value, as compared with the X-axis amplitude WX1 and the Y-axis amplitude WY1.

In each of the three graphs shown in FIG. 4, the horizontal axis indicates time T. In the graph shown in the upper section of FIG. 4, the vertical axis indicates the X-axis angular velocity αX. In the graph shown in the middle section of FIG. 4, the vertical axis indicates the Y-axis angular velocity αY. In the graph shown in the lower section of FIG. 4, the vertical axis indicates the Z-axis angular velocity αZ. The units of the X-axis angular velocity αX, the Y-axis angular velocity αY, and the Z-axis angular velocity αZ are deg/sec.

The graph G21 shown in the upper section of FIG. 4 shows a change in the X-axis angular velocity αX. The graph G22 shown in the middle section of FIG. 4 shows a change in the Y-axis angular velocity αY. The graph G23 shown in the lower section of FIG. 4 shows a change in the Z-axis angular velocity αZ.

The X-axis amplitude WX2 indicates the amplitude of the X-axis angular velocity αX in the graph G21. The Y-axis amplitude WY2 indicates the amplitude of the Y-axis angular velocity αY in the graph G22. The Z-axis amplitude WZ2 indicates the amplitude of the Z-axis angular velocity αZ in the graph G13.

As illustrated in FIG. 4, the X-axis amplitude WX2, the Y-axis amplitude WY2, and the Z-axis amplitude WZ2 are relatively low as compared with the Z-axis amplitude WZ1 shown in FIG. 3, and satisfy the following Equation (4), the Equation (5), and the Equation (6), for example.

$$WZ 2 < THA \qquad ( 4 )$$

$$WZ 2 / WX 2 < THB \qquad ( 5 )$$

$$WZ 2 / WY 2 < THB \qquad ( 6 )$$

Note that the amplitude threshold value THA is, for example, 50 deg/sec. In addition, the amplitude-ratio threshold value THB is, for example, 5.

That is, when the pallet 4 is transported by the truck TR, the Z-axis amplitude WZ2 has a size approximately equivalent to the X-axis amplitude WX2 and the Y-axis amplitude WY2.

When the pallet 4 is transported by the truck TR, the pallet 4 is loaded in the loading space of the truck TR. When the pallet 4 is transported by the truck TR, the angle of rotation with the X-axis being the center and the angle of rotation with the Y-axis being the center are small as compared with a case where the pallet 4 is transported by the fork lift FL, and the frequency of vibration is high due to an increase in the movement velocity. Thus, the X-axis amplitude WX2 is large as compared with the X-axis amplitude WX1, and the Y-axis amplitude WY2 is large as compared with the Y-axis amplitude WY1.

In addition, as the truck TR mainly travels on a public roadway, a change per unit period of time in the traveling direction is small. Thus, the Z-axis amplitude WZ2 is small, as compared with the X-axis amplitude WX2 and the Y-axis amplitude WY2. Thus, the X-axis amplitude WX2, the Y-axis amplitude WY2, and the Z-axis amplitude WZ2 satisfy the Equation (4), the Equation (5), and the Equation (6).

When the X-axis amplitude WX2, the Y-axis amplitude WY2, and the Z-axis amplitude WZ2 satisfy the Equation (4), the Equation (5), and the Equation (6), the movement determining unit 111 determines that the pallet 4 is transported by the truck TR.

Note that, when the X-axis amplitude WX2, the Y-axis amplitude WY2, and the Z-axis amplitude WZ2 satisfy at least one of the Equation (4), the Equation (5), and the Equation (6), the movement determining unit 111 may determine that the pallet 4 is transported by the truck TR.

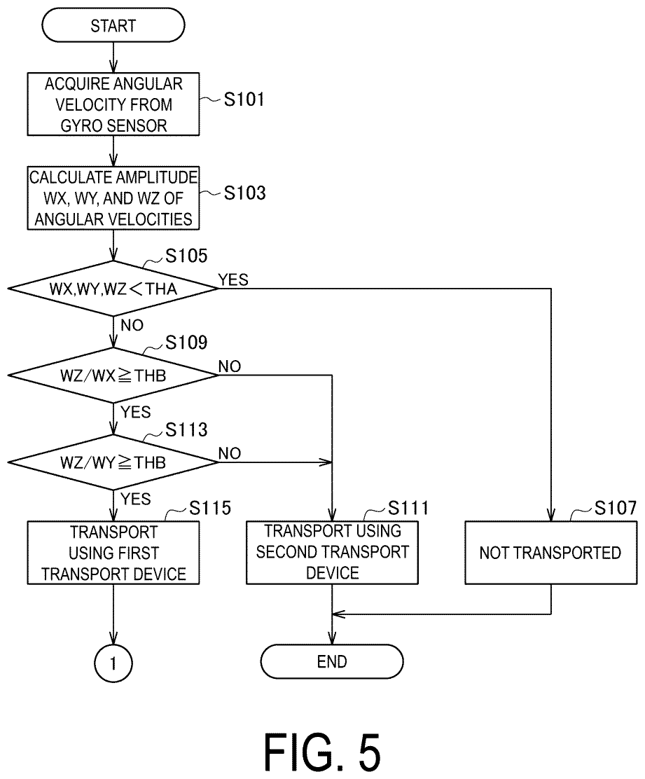

Next, the process of the control unit 11 will be described with reference to FIGS. 5 and 6. FIGS. 5 and 6 are flowcharts showing one example of the process of the control unit 11.

First, as illustrated in FIG. 5, in step S101, the movement determining unit 111 acquires output from the gyro sensor 13. The output from the gyro sensor 13 includes the X-axis angular velocity αX, the Y-axis angular velocity αY, and the Z-axis angular velocity αZ.

Next, in step S103, the movement determining unit 111 calculates the X-axis amplitude WX, the Y-axis amplitude WY, and the Z-axis amplitude WZ. The X-axis amplitude WX indicates the amplitude of the X-axis angular velocity αX in a predetermined period of time. The Y-axis amplitude WY indicates the amplitude of the Y-axis angular velocity αY in a predetermined period of time. The Z-axis amplitude WZ indicates the amplitude of the Z-axis angular velocity αZ in a predetermined period of time. The predetermined period of time is, for example, 10 seconds.

Next, in step S105, the movement determining unit 111 determines whether or not each of the X-axis amplitude WX, the Y-axis amplitude WY, and the Z-axis amplitude WZ is less than the amplitude threshold value THA.

When the movement determining unit 111 determines that each of the X-axis amplitude WX, the Y-axis amplitude WY, and the Z-axis amplitude WZ is less than the amplitude threshold value THA (step S105; YES), the process proceeds to step S107.

In addition, in step S107, the movement determining unit 111 determines that the pallet 4 is not transported, and then, the process ends.

When the movement determining unit 111 determines that at least one of the X-axis amplitude WX, the Y-axis amplitude WY, and the Z-axis amplitude WZ is equal to or more than the amplitude threshold value THA (step S105; NO), the process proceeds to step S109.

Furthermore, in step S109, the movement determining unit 111 determines whether or not the following Equation (7) is satisfied.

$$( WZ / WX ) \geq THB \qquad ( 7 )$$

When the movement determining unit 111 determines that the Equation (7) is not satisfied (step S109; NO), the process proceeds to step S111.

After this, in step S111, the movement determining unit 111 determines that the pallet 4 is transported by the second transport device TE2 such as the truck TR, and then, the process ends.

When the movement determining unit 111 determines that the Equation (7) is satisfied (step S109; YES), the process proceeds to step S113.

After this, in step S113, the movement determining unit 111 determines whether or not the following Equation (8) is satisfied.

$$( WZ / WY ) \geq THB \qquad ( 8 )$$

When the movement determining unit 111 determines that the Equation (8) is not satisfied (step S113; NO), the process proceeds to step S111.

After this, in step S111, the movement determining unit 111 determines that the pallet 4 is transported by the second transport device TE2 such as the truck TR, and then, the process ends.

When the movement determining unit 111 determines that the Equation (8) is satisfied (step S113; YES), the process proceeds to step S115.

After this, in step S115, the movement determining unit 111 determines that the pallet 4 is transported by the first transport device TE1 such as the fork lift FL, and then, the process proceeds to step S117 in FIG. 6.

Next, as illustrated in FIG. 6, in step S117, the first communication control unit 114 turns on the power supply of the GNSS receiving unit 12 to establish communication of the GNSS receiving unit 12 with the GNSS system 2.

Next, in step S119, the reception-state determining unit 112 causes the GNSS receiving unit 12 to receive a GNSS signal from the GNSS system 2. The GNSS signal includes the position signal SP, the orbit signal SE, and the number signal SM. The position signal SP corresponds to the position information PS indicating the position of the GNSS receiving unit 12. The orbit signal SE indicates the orbit information SF concerning a satellite. The number signal SM indicates the number SN of satellites used in calculating the position information PS.

Next, in step S121, the reception-state determining unit 112 determines whether or not the number SN of satellites used in calculating the position information PS is equal to or more than four.

When the reception-state determining unit 112 determines that the number SN of satellites is equal to or less than three (step S121; NO), the process proceeds to step S123.

After this, in step S123, the reception-state determining unit 112 determines that the reception state is not favorable, and then, the process ends.

When the reception-state determining unit 112 determines that the number SN of satellites used in calculating the position information PS is equal to or more than four (step S121; YES), the process proceeds to step S125.

After this, in step S125, the reception-state determining unit 112 determines whether or not the orbit information SF is stored in the orbit-information storage unit 116 for each satellite used in calculating the position information PS.

When the reception-state determining unit 112 determines that the orbit information SF is stored in the orbit-information storage unit 116 for each satellite used in calculating the position information PS (step S125; YES), the process proceeds to step S129. When the reception-state determining unit 112 determines that, for at least one satellite of a plurality of satellites used in calculating the position information PS, the orbit information SF is not stored in the orbit-information storage unit 116 (step S125; NO), the process proceeds to step S127.

Furthermore, in step S127, the reception-state determining unit 112 determines whether or not a signal-to-noise ratio of the position signal SP is equal to or more than the second threshold value TH2. The second threshold value TH2 is “30”, for example.

When the reception-state determining unit 112 determines that the signal-to-noise ratio of the position signal SP is equal to or more than the second threshold value TH2 (step S127; YES), the process proceeds to step S131. When the reception-state determining unit 112 determines that the signal-to-noise ratio of the position signal SP is not equal to or more than the second threshold value TH2 (step S127; NO), the process proceeds to step S123.

After this, in step S123, the reception-state determining unit 112 determines that the reception state is not favorable, and then, the process ends.

When step S125 results in “YES”, the reception-state determining unit 112 determines in step S129 whether or not the signal-to-noise ratio of the position signal SP is equal to or more than the first threshold value TH1. The first threshold value TH1 is “10”, for example.

When the reception-state determining unit 112 determines that the signal-to-noise ratio of the position signal SP is not equal to or more than the first threshold value TH1 (step S129; NO), the process proceeds to step S123.

After this, in step S123, the reception-state determining unit 112 determines that the reception state is not favorable, and then, the process ends.

When the reception-state determining unit 112 determines that the signal-to-noise ratio of the position signal SP is equal to or more than the first threshold value TH1 (step S129; YES), the process proceeds to step S131.

When step S127 results in “YES” and step S129 results in “YES”, the reception-state determining unit 112 determines in step S131 that the reception state is favorable.

Then, in step S133, the acquiring unit 113 acquires the position information PS. In addition, the acquiring unit 113 causes the acquired position information PS to be stored in the position-information storage unit 117. Furthermore, the second communication control unit 115 transmits, to the server device 3, the position information PS that the acquiring unit 113 acquires. Then, the process ends.

### Present Embodiment, Operation, and Effects

As described above with reference to FIGS. 1 to 6, the position acquiring device 1 according to the present embodiment provides the position acquiring device 1 attached to the pallet 4 to be transported and configured to acquire the position information PS indicating the position of the pallet 4 from the GNSS system 2, the position acquiring device 1 including: the movement determining unit 111 configured to determine the movement state of the pallet 4; the reception-state determining unit 112 configured to determine the reception state of the position signal SP from the GNSS system 2; and the acquiring unit 113 configured to acquire the position information PS in accordance with a result of determination by the movement determining unit 111 and a result of determination by the reception-state determining unit 112.

That is, the position information PS is acquired in accordance with the result of determination as to the movement state of the pallet 4 and the result of determination as to the reception state of the position signal SP.

This makes it possible to acquire the position information PS in an appropriate state. Thus, for example, when the position signal from the satellite cannot be received, performing the position determining process is suppressed. This makes it possible to prevent uselessly consuming of the electrical power.

Furthermore, the position acquiring device 1 includes the gyro sensor 13, and the movement determining unit 111 determines the movement state of the pallet 4 on the basis of output from the gyro sensor 13.

This makes it possible to determine the movement state of the pallet 4 on the basis of the output from the gyro sensor 13, which makes it possible to appropriately determine the movement state of the pallet 4.

Furthermore, in the position acquiring device 1, the movement determining unit 111 determines whether the pallet 4 is moved by the first transport device TE1 or is moved by the second transport device TE2 differing from the first transport device TE1, on the basis of the output from the gyro sensor 13.

This makes it possible to appropriately determine whether movement is made by the first transport device TE1 or is made by the second transport device TE2. Thus, it is possible to appropriately determine the movement state of the pallet 4.

In addition, in the position acquiring device 1, the first transport device TE1 includes the fork lift FL, and the second transport device TE2 includes the truck TR.

This makes it possible to appropriately determine whether the pallet 4 is moved by the fork lift FL or is moved by the truck TR, on the basis of the output from the gyro sensor 13. Thus, it is possible to appropriately determine the movement state of the pallet 4.

Furthermore, in the position acquiring device 1, when the movement determining unit 111 determines that the pallet 4 is moved by the first transport device TE1, the reception-state determining unit 112 determines a reception state of the position signal SP, and when the movement determining unit 111 determines that the pallet 4 is moved by the second transport device TE2, the reception-state determining unit 112 does not determine the reception state of the position signal SP.

Thus, when the pallet 4 is moved by the second transport device TE2, the reception state of the position signal SP is not determined. When the pallet 4 moved, for example, by the truck TR as the second transport device TE2 is moved, the pallet 4 is covered with a metal cover, and hence, it is highly likely that the position signal SP cannot be received. Thus, when the position signal from a satellite cannot be appropriately received, it is possible to suppress performing the position determining process.

In addition, the position acquiring device 1 includes the orbit-information storage unit 116, the acquiring unit 113 acquires the orbit information SF concerning a satellite from the GNSS system 2 and causes the orbit information SF to be stored in the orbit-information storage unit 116, and the reception-state determining unit 112 determines a reception state of the position signal SP on the basis of whether or not the orbit information SF is stored in the orbit-information storage unit 116.

Thus, the reception state of the position signal SP is determined on the basis of whether or not the orbit information SF is stored. This makes it possible to appropriately determine the reception state of the position signal SP.

Furthermore, in the position acquiring device 1, when the orbit information SF is stored in the orbit-information storage unit 116, the reception-state determining unit 112 determines that the reception state of the position signal SP is favorable when a signal-to-noise ratio of the position signal SP is equal to or more than the first threshold value TH1.

Thus, when the orbit information SF is stored, it is possible to appropriately determine whether or not the reception state of the position signal SP is favorable by setting an appropriate value for the first threshold value TH1.

In addition, in the position acquiring device 1, when the orbit information SF is not stored in the orbit-information storage unit 116, the reception-state determining unit 112 determines that the reception state of the position signal SP is favorable when a signal-to-noise ratio of the position signal SP is equal to or more than the second threshold value TH2 that is larger than the first threshold value TH1.

Thus, when the orbit information SF is not stored, it is possible to appropriately determine whether or not the reception state of the position signal SP is favorable by setting the second threshold value TH2 to an appropriate value that is larger than the first threshold value TH1.

The memory 11B in which the control program PG according to the present embodiment is recorded provides the memory 11B in which the control program PG is recorded, the position acquiring device 1 including the processor 11A, the position acquiring device 1 being attached to the pallet 4 to be transported and configured to acquire the position information PS indicating the position of the pallet 4 from the GNSS system 2, the control program PG causing the processor 11A to function as: the movement determining unit 111 configured to determine the movement state of the pallet 4; the reception-state determining unit 112 configured to determine the reception state of the position signal SP from the GNSS system 2; and the acquiring unit 113 configured to acquire the position information PS in accordance with a result of determination by the movement determining unit 111 and the reception-state determining unit 112.

Thus, the memory 11B in which the control program PG according to the present embodiment is recorded is able to provide effects similar to those of the position acquiring device 1 according to the present embodiment.

### OTHER EMBODIMENTS

The present embodiment described above is a preferred embodiment. However, the present embodiment described above is not given for the purpose of limitation, and various modification and implementation are possible without departing from the main points thereof.

The present embodiment describes a case where the “target object to be transported” is the pallet 4. However, the embodiment is not limited to this. The “target object to be transported” may be a so-called “roll box pallet”. The “roll box pallet” is also referred to as a roll box cart, a cargo container, or the like. In addition, the “target object to be transported” may be a cargo mounted on the pallet 4.

The present embodiment describes a case where the first transport device TE1 is the fork lift FL, and the second transport device TE2 is the truck TR. However, the embodiment is not limited to this. The first transport device TE1 may be a platform trolley, for example. The second transport device TE2 may be a train.

The present embodiment describes a case where the “recording medium” is the memory 11B. However, the embodiment is not limited to this. It is only necessary that the “recording medium” is a recording medium in which the control program PG is recorded in a computer-readable manner.

For example, for the recording medium, it is possible to use a magnetic, optical recording medium, or a semiconductor memory device. Specifically, the recording medium includes a flexible disk, an HDD, a compact disk read only memory (CD-ROM), a DVD, a Blu-ray (registered trademark) Disc, a magneto-optical disk, a flash memory, a mobile-type or fixed-type recording medium such as a card-type recording medium. In addition, the recording medium may be a non-volatile storage device such as an RAM, a ROM, or an HDD that is an internal storage device that the position acquiring device 1 includes.

It may be possible to achieve each functional component of the position acquiring device 1 by causing the control program PG to be stored in a server device or the like, and downloading the control program PG from the server device to the position acquiring device 1.

In addition, each of the functional components in FIG. 1 is illustrated as functional configurations, and there is no particular limitation on specific embodiments. In other words, it is not necessary to mount hardware that corresponds individually to each of the functional components, and it may be possible to employ a configuration in which a single processor executes a program to realize the functions of a plurality of functional components. Furthermore, in the embodiments described above, some of the functions enabled by software may be enabled by hardware, or some of the functions enabled by hardware may be enabled by software. In addition, the specific details of the configuration of each component of the position acquiring device 1 may be modified as appropriate without departing from the main points of the present disclosure.

Furthermore, the processes of the flowcharts illustrated in FIGS. 5 and 6 are divided into units on the basis of the main content of the processes in order to facilitate understanding of the processing by the control unit 11. The present disclosure is not limited by a way of dividing of the processing units, or their names illustrated in the flowcharts of FIGS. 5 and 6. The processing can be divided into more pieces of processing units on the basis of the processing contents, and can be divided such that one processing unit includes more pieces of processing. In addition, the order of the processes in the flowcharts described above is not limited to the example illustrated in the drawings.

What is claimed is:

1. A position acquiring device attached to a target object to be transported and configured to acquire position information indicating a position of the target object from a GNSS system, the position acquiring device comprising:
a movement determining unit configured to determine a movement state of the target object;
a reception-state determining unit configured to determine a reception state of a position signal from the GNSS system; and
an acquiring unit configured to acquire the position information in accordance with a result of determination by the movement determining unit and a result of determination by the reception-state determining unit.

2. The position acquiring device according to claim 1 further comprising:
a gyro sensor, wherein
the movement determining unit determines the movement state of the target object on a basis of output from the gyro sensor.

3. The position acquiring device according to claim 2, wherein
the movement determining unit determines whether the target object is moved by a first transport device or is moved by a second transport device differing from the first transport device, on a basis of the output from the gyro sensor.

4. The position acquiring device according to claim 3, wherein
the first transport device includes a fork lift, and
the second transport device includes a truck.

5. The position acquiring device according to claim 3, wherein
when the movement determining unit determines that the target object is moved by the first transport device, the reception-state determining unit determines a reception state of the position signal, and
when the movement determining unit determines that the target object is moved by the second transport device, the reception-state determining unit does not determine the reception state of the position signal.

6. The position acquiring device according to claim 1 further comprising:
a storage unit, wherein
the acquiring unit acquires orbit information concerning a satellite from the GNSS system, and causes the orbit information to be stored in the storage unit, and
the reception-state determining unit determines a reception state of the position signal on a basis of whether or not the orbit information is stored in the storage unit.

7. The position acquiring device according to claim 6, wherein
when the orbit information is stored in the storage unit, the reception-state determining unit determines that the reception state of the position signal is favorable when a signal-to-noise ratio of the position signal is equal to or more than a first threshold value.

8. The position acquiring device according to claim 7, wherein
when the orbit information is not stored in the storage unit, the reception-state determining unit determines that the reception state of the position signal is favorable when the signal-to-noise ratio of the position signal is equal to or more than a second threshold value that is larger than the first threshold value.

9. A recording medium, of a position acquiring device, in which a position acquiring program is recorded, the position acquiring device including a processor, the position acquiring device being attached to a target object to be transported, the position acquiring device being configured to acquire position information indicating a position of the target object from a GNSS system, the program causing the processor to function as:
a movement determining unit configured to determine a movement state of the target object;
a reception-state determining unit configured to determine a reception state of a signal from the GNSS system; and
an acquiring unit configured to acquire the position information in accordance with a result of determination by the movement determining unit and a result of determination by the reception-state determining unit.
